(19) United States
(12) Patent Application Publication
(10) Pub. No.: US 2004/0208953 A1
(43) Pub. Date: Oct. 21, 2004

(54) Baiting system for suppressing populations of insects such as mediterranean and carribean fruit flies (Diptera: Tephritidae)

(76) Inventor: Robert R. Heath, Miami, FL (US)

Correspondence Address: USDA, ARS, OTT, 5601 SUNNYSIDE AVE, RM 4-1159, BELTSVILLE, MD, 20705-5131, US

(21) Appl. No.: 10/417,747

(22) Filed: Apr. 17, 2003

(51) Int. Cl. A23L 1/00

(52) U.S. Cl. 426/1

(57) ABSTRACT

A long lasting insect baiting system containing wax (e.g., paraffin, GulfWax), a hardener (e.g., Elvax-60), an emulsifier (e.g., SPAN 60), an oil (e.g., food oils (preferably related to insect feeding) such as corn oil, molasses, glycerol or corn syrup), a chemical attractant (e.g., ammonium acetate or carbonate) and a phagostimulant (e.g., food such as proteinaceous materials such as protein and hydrolyzed protein or feeding stimulant, such as sugars like sucrose), optionally a visual attractant (e.g., food coloring), and optionally a toxicant (e.g., avermectin, methomyl, spinosad, phloxine B). A method for attracting insects involving placing in an area where the insects are to be attracted an insect attracting effective amount of the composition described herein.

### BACKGROUND OF THE INVENTION

The present invention relates to a long lasting insect baiting system containing wax (e.g., paraffin, GulfWax), a hardener (e.g., Elvax-60), an emulsifier (e.g., SPAN 60), an oil (e.g., food oils (preferably related to insect feeding) such as corn oil, molasses, glycerol or corn syrup), a chemical attractant (e.g., ammonium acetate or carbonate) and a phagostimulant (e.g., food such as proteinaceous materials such as protein and hydrolyzed protein or feeding stimulant, such as sugars like sucrose), optionally a visual attractant (e.g., food coloring), and optionally a toxicant (e.g., avermectin, methomyl, spinosad, phloxine B). The present invention also relates to a method for attracting insects involving placing in an area where the insects are to be attracted an insect attracting effective amount of the composition described herein.

Tephritid fruit flies including the Mediterranean fruit fly (medfly), Ceratitis capitata (Wiedemann), and the Caribbean fruit fly (caribfly), Anastrepha suspensa (Loew), are some of the many fruit flies that pose a serious invasive threat to citrus produced worldwide. However, damage by these pests is not limited to citrus. More than 350 different hosts, including stone fruits like plums and peaches, and cash crops like tomatoes and peppers, have been recorded as hosts for the medfly (Liquido, N.J., et al., Misc. Publ. Entomol. Soc. Amer., 77: 1-52 (1991)). These invasive species are quarantine pests and strict monitoring protocols are in place to detect introduction of these pests. Populations of the medfly are sustained year-round in many areas such as Mexico and Guatemala by a succession of preferred host plants that provide almost continuous breeding sites. The Caribbean fruit fly is established in Florida, Puerto Rico and Jamaica and also survives year-round.

Currently, techniques for medfly eradication include sterile insect release technology (SIT)(Gilmore, J. E., Sterile insect technique (SIT), pp. 375-386, In A. S. Robinson & g. Hooper (eds.), World crop pests, vol. 3B, Fruit flies, their biology, natural enemies and control, Elsevier, Amsterdam (1989)) and aerial bait sprays (Roessler, Y., Insecticidal bait and cover sprays, pp. 329-335, In A. S. Robinson & g. Hooper [eds.], World crop pests, vol. 3A, Fruit flies, their biology, natural enemies and control, Elsevier, Amsterdam (1989)). For SIT to be cost-effective, populations must be reduced prior to fly release and recurring infestations require other management strategies such as insecticide applications. Although many aerial bait spray eradication efforts are done with naturally occurring “biosafe” insecticides, there remains public concern regarding environmental effects and adverse effects on non-target organisms. Aerial bait spray is costly, requires a number of applications due to short field efficacy of the toxicant and presents a concern to organic farming practices. Thus there is a need for alternatives to the currently used bait sprays. Development of bait stations or baiting systems may afford a redress and/or provide a supplementary mechanism for pest fruit fly suppression. This requires new technologies to be developed that would incorporate an attractant (preferably female-biased), a phagostimulant, a visual attractant and a toxicant. Bait stations minimize costs and risks to the environment and are placed in the insect host habitat at spatially localized locations. Deployment of attractacide systems that are spatially localized generally do not require the extensive registration needed for aerial- or ground-applied bait sprays. There are several types of bait stations in the prior art: see, for example, U.S. Pat. Nos. 4,208,829; 4,841,669; 5,033,229; 5,152,097; 5,548,922; 6,219,960;6,370,813; 6,401,384;6,502,348.

A bait station or baiting system needs to have a potent feeding stimulant such that when attracted the insect feeds and consumes the toxicant. In addition, it is desired that the bait station or baiting system should last at least a month. Although the concept is simple, the fact that bait stations or baiting system are not available is due to some basic problems inherent to the development of such systems. Of considerable difficulty in designing a bait station or baiting system is the ability to provide a mechanism such that the feeding stimulant and toxicant is always on the surface which is compromised due to the extreme solubility of known feeding stimulants in water, thus rain will dissolve the feeding stimulant which renders the station ineffective. Difficulty arises in the development of a matrix that will dissolve or incorporate a water soluble material (e.g., phagostimulant) such as sugar as well as an attractant and toxicant. What is needed is a composite in which organic material is combined with water soluble materials in a form that is solid and can be molded. Of critical importance is that the matrix does not repel the fly or inhibit feeding. We report herein the development of a baiting system that will attract insects (such as caribflies and medflies) and that will kill attracted insects for approximately two months during times of considerable rain and at least approximately four months under dry conditions. The availability of such baiting systems will afford an additional tool for use in developing management strategies for invasive pests such as caribflies and medflies.

### SUMMARY OF THE INVENTION

The present invention concerns a long lasting insect baiting system comprising wax (e.g., paraffin, GulfWax), a hardener (e.g., Elvax-60), an emulsifier (e.g., SPAN 60), an oil (e.g., food oils (preferably related to insect feeding) such as corn oil, molasses, glycerol or corn syrup), a chemical attractant (e.g., ammonium acetate or carbonate) and a phagostimulant (e.g., food such as proteinaceous materials such as protein and hydrolyzed protein or feeding stimulant, such as sugars like sucrose), optionally a visual attractant (e.g., food coloring), and optionally a toxicant (e.g., avermectin, methomyl, spinosad, phloxine B).

The present invention also concerns a method for attracting insects involving placing in an area where the insects are to be attracted an insect attracting effective amount of the composition described herein.

### BRIEF DESCRIPTION OF THE DRAWINGS

FIG. 1 shows the effect of minimum feeding time on percent mortality of Caribbean fruit fly females exposed to baiting systems with 1% AI spinosad (sample size was 80 flies tested in 8 groups of 10 flies per test; mortality of flies on baiting systems with toxicant (black bars) was compared to mortality of flies on baiting systems without toxicant (controls, gray bars)); and

FIG. 2 shows percent mortality in field cages tests with Mediterranean fruit flies (mortality of field cages with baiting systems and toxicant (black bars) was compared to mortality in field cages with baiting systems containing no toxicant (controls, gray bars); amount of rain for the week are reported in the row with parenthesis; weeks containing an asterisk indicate that no significant differences occurred).

### DETAILED DESCRIPTION OF THE INVENTION

The present invention relates to a long lasting insect baiting system comprising wax (e.g., paraffin, GulfWax), a hardener (e.g., Elvax-60), an emulsifier (e.g., SPAN 60), an oil (e.g., food oils (preferably related to insect feeding) such as corn oil, molasses, glycerol or corn syrup), a chemical attractant (e.g., ammonium acetate or carbonate) and a phagostimulant (e.g., food such as proteinaceous materials such as protein and hydrolyzed protein or feeding stimulant, such as sugars like sucrose), optionally a visual attrantant (e.g., food coloring), and optionally a toxicant (e.g., avermectin, methomyl, spinosad, phloxine B).

The insect baiting system (IBS) is a device that is spatially discrete, attracts targeted pest insects, and may contain an agent (e.g., toxicant) that renders the insect unable to cause further damage or injury. It generally will contain a mechanism to debilitate the insect such as a toxicant.

One key advantage of the invention is that the insect baiting system is surprisingly long lasting when exposed to ambient environmental conditions. For example, it will surprisingly kill attracted insects for approximately two months during times of considerable rain and at least approximately four months under dry conditions. This is very unexpected because of prior problems in this field of providing a mechanism such that the feeding stimulant and toxicant is always on the surface which is compromised due to the extreme solubility of known feeding stimulants in water, thus rain will dissolve the feeding stimulant which renders the station ineffective, and the difficulty in the development of a matrix that will dissolve or incorporate a water soluble material (phagostimulant) such as sugar as well as an attractant and toxicant. Without being bound by theory, it is believed that the oil in the present invention is important in getting the phagostimulant and toxicant to the surface.

The wax is generally paraffin which can be selected from many products which are well known in the art, including but not limited to bees wax, vegetable based waxes such as soywax (soybean based), and hydrocarbon based waxes such as Gulf Wax Household Paraffin Wax (Royal Oak Sales, Inc., Roswell, Ga.; paraffin wax, avg. m.p. 53C (hexacosane), high molecular weight hydrocarbons). Gulf Wax is preferred.

The hardener raises the meltpoint and thereby hardens the wax, improves gloss and color brightness, improves flexibility and adds toughness to the baiting systems. The hardener can be selected from many products which are well known in the art, including but not limited to Elastollan®, Luran®, Terluran®, Ultramid® T, ACRYLITE PLUS®, Ferrene, ARCEL®, Crystal PS, Cevian®-V, and Elvax (DuPont Industrial Polymers, Wilmington, Del.; contents: ethylene/vinyl acetate copolymer resins). Elvax-60 is preferred.

The emulsifier can be selected from many products which are well known in the art, including but not limited to sorbitan monolaurate (anhydrosorbitol stearate, molecular formula C₂₄H₄₆O₆), arlacel 60, armotan ms, crill 3, crill k3, drewsorb 60, durtan 60, emsorb 2505, glycomul s, hodag sms, ionet s 60, liposorb s, liposorb s-20, montane 60, ms 33, ms33f, newcol 60, nikkol ss 30, nissan nonion sp 60, nonion sp 60, nonion sp 60r, rikemal s 250, sorbitan c, sorbitan stearate, sorbon 60, sorgen 50, span 55, and span 60; other Sorbitan fatty acid ester that may be used include sorbitan monopalmitate, sorbitan monostearate, sorbitan tristearate, sorbitan monooleate, sorbitan sesquioleate, sorbitan trioleate, sorbitan monooleate, sorbitan trioleate. Span 60 is preferred.

The oil should be related to insect feeding and can be selected from many products which are well known in the art, including but not limited to food oils such as corn oil, molasses, glycerol, corn syrup (e.g., Karo Light Corn Syrup), or any sweet syrup such as maple, citrus, or chocolate. The oil is generally selected to be appealing to the target insect.

The chemical attractant should be directed against the target insect and can be selected from many products which are well known in the art, including but not limited to ammonium acetate or ammonium carbonate. Acetic acid vapor can be provided by compounds that produce volatilized acetic acid, for example, aqueous acetic acid, glacial acetic acid, glacial (concentrated) acetic acid, or ammonium acetate. Ammonia vapor can be provided by compounds that produce volatilized ammonia, for example, ammonium carbonate, ammonium bicarbonate, ammonium acetate, etc. Ammonium acetate is most preferred for providing acetic acid and ammonia vapors.

The phagostimulant should be directed against the target insect and can be selected from many products which are well known in the art, including but not limited to proteinaceous materials such as protein and hydrolyzed protein (e.g., Torulla yeast, NuLure) or sugars such as sucrose.

The visual attractant may be any coloring agent or pigment that imparts a preferred color for the targeted insect. For example, with fruit flies this is usually green, orange or red; green food color is preferred.

The toxicant should be directed against the targeted insect, and can be selected from many products which are well known in the art, including but not limited to methomyl(E.I. DuPont De Nemours and Co., Newark, DL; 98% (AI)), Malathion, dichlorvos, naled, organophosphorus toxicants, carbamates, inorganic toxicants, and avermectin, spinosad, phloxine B. Toxicants which may be useful in this invention are those which will not adversely affect the attractiveness of the composition of the invention. Insect growth regulators may also be used.

An effective amount of the insect chemical attractant or insect visual attractant is defined as that amount of each of these compounds that attracts insects at a rate significantly higher than insects are attracted when the insect chemical attractant or insect visual attractant is absent. An effective amount of the insect toxicant is defined as that amount which will kill the targeted insect.

Other compounds and materials may be added provided they do not substantially interfere with the attractant activity of the composition of the invention. Whether or not an additive substantially interferes with the attractant activity can be determined by standard test formats, involving direct comparisons of efficacy of the composition of the present invention without an added compound and the composition of the present invention with an added compound.

The baiting system may be prepared by the following procedure: Heating the basic ingredients (paraffin (e.g., GulfWax, Royal Oak Sales, Roswal, Ga.), a hardener (e.g., Elvax-60, Swan Candles, Tacoma, Wash.) and a emulsifier (e.g., SPAN 60, Uniquema, Wilmington Del.) in a ratio of about 8:1.5:0.5, respectively) with mixing to approximately 80° C. Adding to the melted mixture oil and sugar (e.g., either glycerol or corn syrup (Karo, Bestfoods, Englewoods Cliff, N.J.) or corn syrup and granulated sugar), optionally an effective amount of an insect visual attractant (e.g., green food coloring (McCormick & Co., Hunt Valley, Md.)), optionally an effective amount of an insect chemical attractant (e.g., ammonium acetate), and optionally an effective amount of an insect toxicant (e.g., triguard, methomyl, avermectin, spinosad, phloxine (suredye), dimethoate). The mixture may be mixed for approximately 5 min and then poured into molds that have been chilled at 0° C. for 10 minutes; the resulting baiting system may be placed in a freezer for approximately 20 minutes.

The baiting system may be in any shape (e.g., cylinders, strips, sheets, rods, ropes).

It is envisioned that the chemical attractants of the invention would be useful in detecting, surveying, monitoring and/or controlling insects (e.g, frugivorous pest insects, especially Anastrepha ludens (Loew) and Anastrepha suspensa (Loew)).

Caribflies and medflies were used as a model system in the examples below. However, the system is applicable to the control of other insects (e.g., frugivorous pest insects). One of ordinary skill in the art could readily determine which sugar, insect visual attractant, insect chemical attractant, or insect toxicant are needed to attract or kill specific insect populations.

The present invention also concerns a method for attracting insects involving placing in an area where the insects are to be attracted an insect attracting effective amount of the composition described herein. The insect attracting effective amount of the composition can be readily determined by one skilled in the art in part by using the examples below.

The following examples are intended only to further illustrate the invention and are not intended to limit the scope of the invention as defined by the claims.

### EXAMPLES

Material and Methods:

Composite: Initial studies were conducted to develop a composite that would provide a flowable material containing an insecticide and a feeding stimulant that would solidify after being poured or molded. Of approximately 120 different matrices that were prepared, six were selected for further evaluation. The basic ingredients consisted of paraffin (GulfWax Household Paraffin Wax (Contents: paraffin wax, avg. m.p. 53C (hexacosane), High Molecular Weight Hydrocarbons), Royal Oak Sales, Roswal, Ga.), a hardener (Elvax-60 (contents: ethylene/vinyl acetate copolymer resins), Swan Candles, Tacoma, Wash.) and a emulsifier (SPAN 60 (contents: sorbitan monostearate), Uniquema, Wilmington, Del.) in a ratio of 8:1.5:0.5, respectively. These were heated with mixing to approximately 80° C. To the melted mixture either glycerol or corn syrup (Karo (contents: light corn syrup, high fructose corn syrup, salt, vanilla), Bestfoods, Englewoods Cliff, N.J.) or corn syrup and granulated sugar were added. To a 100 g batch containing paraffin, Elvax, and SPAN, 20 ml of glycerol or corn syrup were added. When sugar was used 2 g were added to the composite. Two drops of food coloring (McCormick & Co., Hunt Valley, Md.) were added to all composites to provide a visual cue, for the purposes of these studies green food coloring (contents: water, propylene glycol, FD&C Yellow 5, Blue 1 and propylparaben) was used. Insecticide was added so that the percentage required amounted to percent of total composite as active ingredient (AI). The composite was mixed for approximately 5 min and then poured into insect diet trays that had been chilled at 0° C. for 10 minutes. Cylinders formed were approximately 2.4 cm in diameter and approximately 2.5 cm in height. After pouring the composite the trays were placed in a freezer for approximately 20 minutes.

Bioassays: Caribflies and medflies were obtained as pupae from colonies maintained at the USDA/ARS laboratory in Miami, Fla., and at the Moscamed rearing facility in Petapa, Guatemala, respectively. Flies were given water and adult food (3:1 mixture of refined cane sugar: protein hydrolysate); caribflies were maintained in screen cages (30 cm³) and medflies in cardboard containers (1 liter) with the lid replaced by a cloth screen. Adult flies were held and bioassays were conducted in laboratories with photoperiods of 12:12 (L:D) h at room temperature and ambient humidity. Females used in laboratory tests were obtained from mixed-sex cages and ranged in age from 3-16 d post-eclosion. Unless stated otherwise, the baiting systems were hung individually in cylindrical screen cages (19.3 cm diam by 15.3 cm), ten females were added to each cage, baiting systems were removed after 4 or 24 h, and mortality was recorded after 4 and/or 24 h Flies were provided water during the tests.

Baiting System Composite Tests: Composites tested were: paraffin, Elvax, Span with corn syrup (control); paraffin, Elvax, Span, corn syrup and 1% AI of Conserve SC (Spinosyn A and Spinosyn D-11.6% AI, Dow AgroSciences, Indianapolis, Ind.); paraffin, Elvax, Span, glycerol and 1% spinosad; paraffin, Elvax, Span, corn syrup, sugar and 1% spinosad and paraffin, Elvax, Span, sugar and 1% spinosad. Baiting systems were held with the flies for either 4 or 24 h, and number of adults that were dead after 24 h was used for analysis. There were five replicates of the composite tests, and the baiting systems were hung in trees at the Miami ARS station when not being used in the bioassays.

Insecticide Comparisons: Cylindrical baiting systems were prepared as described above with the addition of 0.25 and 1.0% AI triguard (Cyromazine-75% AI, Ciba-Geigy Corp., Greensboro, N.C.), methomyl (Lannate-90% AI, Dupont Ag Products, Wilmington, Del.), avermectin (Avido 0.15C-1.9% Al, Merck Agvet Division, Rahway, N.J.), spinosad, suredye (Red Dye 28-Phloxine B, Hilton-Davis, Cincinnati, Ohio) or dimethoate (CYGON 2E-23.4% AI, American Cyanamid Corp., Princeton, N.J.). Baiting systems were held with caribflies for 4 h and percent mortality was determined after 24 h. Tests were replicated ten times.

Comparison of Efficacy of Baiting System Cylinders and Baiting System Strips: Trials were conducted with baiting systems that were cylindrical in shape as described and baiting systems that were flat and cut into strips. Cylinders and strips were prepared using the composite consisting of 80 g paraffin, 15 g Elvax, 5 g SPAN, 20 ml corn syrup and 2 g of sugar. When making sheets the composite was poured in trays that were pre-cooled and Teflon-lined, and the sheets were cut into 2 cm by 4 cm strips approximately 4 mm thick. Comparisons were made among cylinders and strips that contained no insecticide, 2% AI spinosad or 1% AI methomyl. Tests were conducted using female medflies. There were three replicates obtained weekly during a 78 d period. When baiting systems were not being bioassayed they were hung in trees at the Moscamed facility in Metapa, Guatemala.

Comparison of Time of Fly on Baiting Systems and Mortality: Cylindrical baiting systems having a composite consisting of 80 g paraffin, 15 g Elvax, 5 g SPAN, 20 ml corn syrup and 2 g of sugar with no insecticide and with 1% Al spinosad were prepared. For each replicate 30 caribflies were exposed for 30 s, 1 and 3 min to the control and treatment. Mortality was recorded after 24, 48, 72 and 96 h and the test was replicated eight times. Flies were provided with sugar water after exposure to the baiting systems.

Incorporation of Attractant into the Baiting System: Cylindrical baiting systems having a composite consisting of 80 g paraffin, 15 g Elvax, 5 g SPAN, 20 ml corn syrup and 2 g of sugar and 1% spinosad were prepared and 1, 2 or 4 g of ammonium acetate (Aldrich Chemical Co., Milwaukee, Wis.) were added to the composite. Baiting systems were hung inside plastic McPhail traps (Multilure trap, Better World Manufacturing Co., Miami, Fla.; Newell, W., J. Econ. Entomol., 29: 116-120 (1936); McPhail, M., J. Econ. Entomol., 32: 758-761 (1939)). In addition to the baiting systems, a 1,4-diaminobutane (putrescine) lure (BioLure, Suterra, LLC Bend, Oreg.) was also added to the McPhail trap. Approximately 300 ml of water containing 5% propylene glycol were added to the bottom of the McPhail trap as the retention agent. For comparative purposes, these were compared to McPhail traps baited with the food-based synthetic lures ammonium acetate and putrescine (Heath, R. R., et al., J. Econ. Entomol., 88:1307-1315 (1995); BioLure, Suterra, LLC; Bend, Oreg.). The traps were deployed in a block of guava trees at the ARS station in Miami, Fla. and the number of caribflies captured was recorded biweekly for four weeks. Five rows of traps each containing the four treatments were used and traps were rotated to the adjacent position when they were checked.

Additional studies were conducted to determine if the addition of ammonium acetate would degrade the insecticide. Baiting system strips were prepared with 80 g paraffin, 15 g Elvax, 5 g SPAN, 20 ml corn syrup and 2 g of sugar, 1% spinosad, and 1% ammonium acetate. Mortality over time was determined with medflies using the same bioassay as reported for the comparison of baiting system cylinders and baiting system strips. Tests were conducted for a 95 d period during the raining season and the baiting systems were hung in trees when not being used in the bioassay.

Field Cage Efficacy Studies: Three screen tents approximately 3 m high and 7 m² were placed on wooden platforms at the Miami ARS station and two guava plants in pots were placed in each tent in a shaded area. Baiting system strips containing the composite of 80 g paraffin, 15 g Elvax, 5 g SPAN, 20 ml corn syrup, 2 g of sugar, and 1% ammonium acetate were prepared. Baiting systems without insecticide were compared to those with 1% AI methomyl or 1% AI spinosad. A baiting system was hung on each guava plant and tests were conducted to compare mortality with baiting systems containing no insecticides with baiting systems containing either methomyl or spinosad. Two hundred sexually mature female caribflies were released in the morning in each of the tents and mortality was determine after 48 h. Similar studies were conducted in coffee finca Sansabol located near Antigua, Guatemala. Screen field cages (Synthetic Industries, Chattanooga, Tenn.) without a floor and 45 m² (2.5 meters high and 6 meters wide and 7.5 meters long) were placed over approximately 10 coffee trees. Three baiting system strips containing 1% AI spinosad were place in trees and compared to mortality of flies in tents that contained three baiting systems without insecticide. Three control tents and three treatment tests were used for each replicate. Two hundred mated medflies (50% of each sex) were released in the field cage and the estimate of surviving flies was made using 4 yellow panels approximately 25 cm² that were placed in the cages after 48 h that contained stickum. The yellow panels were left in the cages and fly counts were made 24 h later. This experiment was conducted weekly for 10 wk and treatments were rotated to an adjacent tent after each experiments. Weekly rainfall was recorded during the experiment.

Statistical Analysis: Number of dead insects or percent mortality was analyzed with oneway analysis (ANOVA) using Proc GLM (SAS Institute, 1985, SAS/STAT guide for personal computers, version 6 edition., SAS Institute, Cary, N.C.). Data were subjected to the Box-Cox procedure which is a power transformation that regresses log-transformed standard deviations (y) against log-transformed means (x) (Box, G. E. P., et al., Statistics for Experimenters, An Introduction to Design, Data Analysis, and Model Building, J. Wiley & Sons, New York, N.Y. (1978)), and data were transformed to stabilize the variance before analysis when necessary. Separate analyses were conducted for amount of time the flies were exposed to the baiting system (e.g., composite test) or for insecticide concentration (pesticide comparison).

Results:

Difficulty was encountered in initial attempts to find a composite that could be poured and which would solidify without the separation of the components. Additionally, many of the composites did not have suitable mechanical properties required for hanging and/or were not durable when exposed to rain. Another difficulty encountered was with the ability to provide the toxicant and feeding stimulant on the surface of the baiting system with a reasonable longevity. Initial trials required that the composite be poured into a chilled container and then immediately placed in cold temperature. The three components that comprised the basic composite were paraffin, a hardener (Elvax 60) and a emulsifier (SPAN 60) in a ratio of 8:1.5:0.5 respectively. While this material was not suitable without additives it did provide a basic composite that would permit additional material(s) to be added to the matrix. Comparison of mortality of caribflies exposed to (1) the three component (paraffin, Elvax, SPAN) basic matrix (3CBM) and corn syrup (control), (2) 3CBM, corn syrup and spinosad, (3) 3CMB, glycerol and spinosad, (4) 3CBM, sugar and spinosad, and (4) 3CBM, sugar, corn syrup and spinosad is shown in Table 1. All composites containing a toxicant resulted in significant mortality compared to the control. The composite containing the 3CBM, sugar and corn syrup resulted in the highest mortality after 24 h and was the easiest to prepare and pour when compared to the other composites. Also separation of the matrix was at a slower rate when compared to the other composites. This composite was used for all additional studies and is referred to as BSC.1

A comparison of the efficacy of the baiting system was made to determine if other materials and toxicants were amenable additives to BSC.1. To BSC.1 was added 0.25% AI of triguard, methomyl, avermectin, spinosad, phloxine (suredye), and dimethoate. This series was also tested with 1% AI of the same materials added to the BSC.1 and the results are shown in Table 2. When 0.25% AI was added to the BSC.1 an increase in mortality was obtained with methomyl, avermectin, spinosad, suredye, and dimethoate compared to triguard and BSC.1 without toxicant. BSC.1 containing dimethoate had the highest mortality but was not significantly different than mortality observed with suredye, spinosad avermectin and methomyl. When 1% AI of the various materials were tested dimethoate again had the highest mortality but mortality was not significantly different than that observed with methomyl and spinosad. Mortality with these toxicants were significantly greater than that obtained with avermectin, suredye, triguard, and BSC.1 without toxicant. Although avermectin resulted in significantly lower mortality than spinosad, methomyl and dimethoate mortality was greater than observed with suredye, triguard and BSC.1 without toxicant. Mortality with suredye was significantly greater than that observed with triguard. Interestingly, suredye when used at 0.25% AI level resulted in 83.0% mortality and at 1% AI resulted in only 22.0% mortality.

Comparison of efficacy of baiting system cylinders and baiting system strips was done to determine if sheets of BSC.1 could be made thus minimizing the amount of material needed for a baiting system. Tests were conducted with cylinders and strips made from BSC.1 and compared to formulations containing 1% AI of either methomyl or spinosad. Tests were conducted for 79 d in Guatemala with medflies and mortality was recorded after 4 and 24 h. Averages over the period from week 5 to week 11 are shown in Table 3. Mortality was high in all baiting systems that contained insecticide and there was no significant difference among the toxicant containing baiting systems. Mortality was lowest in the baiting systems that did not contain toxicant.

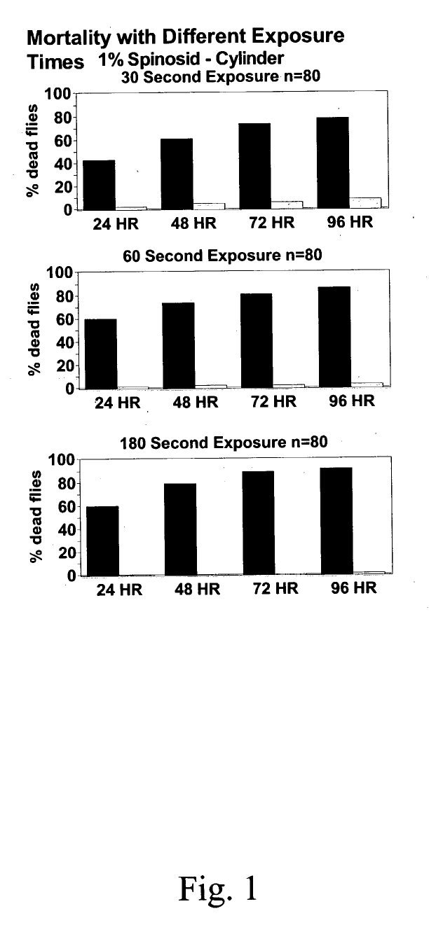

Minimum feeding time to obtain lethal dose was determined by exposing caribflies to BSC.1 cylinders containing 1% AI of spinosad for 30 s, 1 and 3 min and comparing mortality to flies exposed only to BSC.1 cylinders. Mortality was recorded after 24, 48, 72 and 96 h. and shown in FIG. 1. Mortality of the flies exposed to only BSC.1 was 3.25±0.27% and fly mortality increased with time for flies exposed to BSC.1 containing spinosad. The only significant difference based on time of exposure was observed at 96 h where flies exposed for 30 s resulted in significantly less mortality 78.5%, compared to flies exposed for 3 min (F=3.52; df=2, 21; P=0.0479). A 1 min exposure with 88.1% mortality was not significantly different than mortality observed with either 30 s or 3 min exposure that resulted in 92.5% mortality.

Ammonium acetate is a well known attractant for many economically important fruit flies and tests were conducted to determine if the BSC.1 cylinders could be made that would release ammonia and acetic acid. Field tests conducted using McPhail traps containing a commercial formulation of putrescine and either 1, 2 or 4 g loads of ammonium acetate added to the baiting systems and were compared to McPhail traps with a controlled release of ammonium acetate and putrescine. The results of the trap capture are reported in Table 4. The cylinders containing 1 g of ammonium acetate captured significantly fewer caribflies than the 4 g cylinders and the commercial lure. Capture with 2 and 4 g of ammonium acetate in the BSC.1 cylinders was not significantly different than trap capture with the commercial formulation of ammonium acetate.

Field cage efficacy studies were conducted in Miami, Fla. with caribflies to determine if fly populations could be reduced in the presence of baiting systems (considerable fly mortality did occur due to predators (mainly ants and spiders) that were able to get inside the field cages). Results from counts made at 48 h indicated that of the 200 flies released an average 75±23.6 were still alive compared to 3.6 flies±6.4 that could be found in tents containing the BSC.1 with methomyl and 5.8±2.4 flies in tents containing BSC.1 and spinosad. Fly capture in tents containing BSC.1 with an insecticide was significantly less than the control tents (F=3.61; df=3, 42; P=0.0208, n=13).

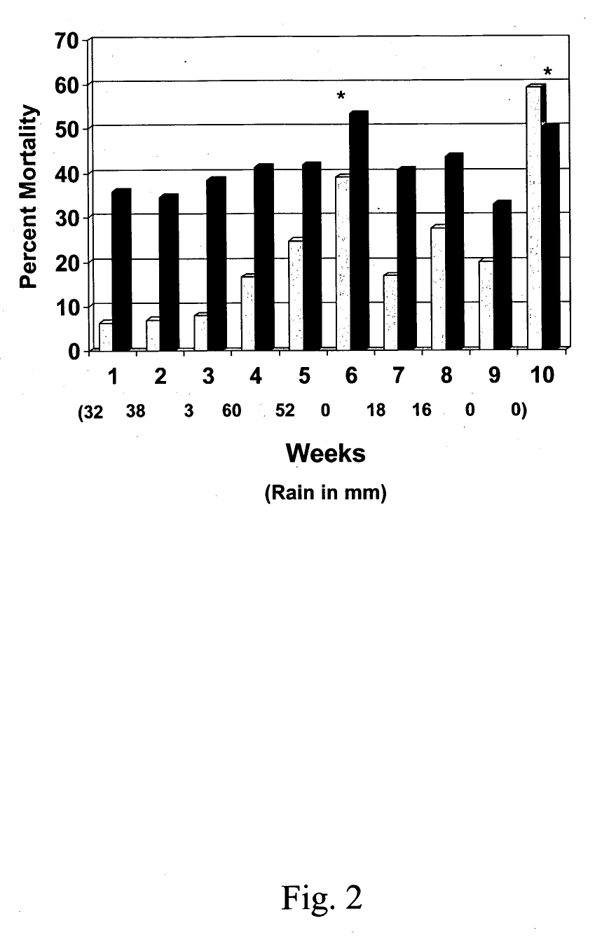

Results of field cage efficacy studies conducted in Guatemala using BSC.1 with 2% spinosad are shown in FIG. 2. Tests were conducted over a ten week period during the rainy season. Although considerable amount of predation of the released flies occurred in field cages due to spiders and ants, cages containing the BSC.1 with insecticide resulted in significantly fewer flies at the end of the tests for eight of the ten weeks the tests were conducted. During the first three weeks few flies were found in the cages containing baiting systems with toxicant. Increases in rain resulted in decreased mortality with the baiting systems and no significant differences were observed when the control cages were compared to the cages containing the baiting system and toxicant; no rain occurred during week six and seven and significant mortality was restored in cages containing baiting systems and toxicant.

Discussion:

Baiting system is a very general term used for a method of attracting arthropod pest species for the purpose of detecting or controlling damaging pest populations. Baiting systems have been developed for a wide variety of pest species, pest groups, and agricultural systems.

We have now discovered the primary system for formulation of a composite that allows for incorporation of various insecticides, feeding stimulants and attractants. As the initial research continued it was determined that the matrix of ingredients would have to contain a wax, a hardener to provide mechanical stability, and an emulsifier that would decrease the rate of separation when other materials were added and the baiting system made. Use of an oil, such as corn syrup, was a surprisingly important additive to the composite. Without the oil many of the baiting systems would become brittle when exposed to environments in places such as Florida and Guatemala. Insect mortality for insects tested with baiting systems without an oil were typically less that two weeks. Surprisingly, baiting systems that included the oil resulted in a surface that was oily over several months. Without being bound by theory, the composite with oil may provide the transport mechanism via either flow through the matrix or erosion of the matrix for movement of the insecticide, sugar and attractant over time to the surface of the baiting system. As reported the longevity of the baiting system described is approximately 60 d in the rainy season and at least 200 d in drier climates.

The baiting systems may be used in management of insects which affect stored products, such as ants, moths, weevils, and other insects of economic importance. The ability to mold the baiting system facilitates the production of balls similar to “paint balls” that can applied with compressed air guns. Attractants previously reported for fruit flies may be added to the baiting systems and various moldings of the baiting systems may be visually more attractive to insects.

All of the references cited herein are incorporated by reference in their entirety. Also incorporated by reference in their entirety are the following U.S. Patents: U.S. Pat. Nos. 6,224,890; 5,939,062; 5,907,923; 5,766,617; 4,992,268.

Thus, in view of the above, the present invention concerns (in part) the following:

A composition (e.g., insect baiting system) for attracting insects, comprising (or consisting essentially of or consisting of) wax, a hardener, an emulsifier, an oil, a chemical attractant and a phagostimulant, optionally a visual attractant, and optionally a toxicant.

The above composition, wherein the wax is paraffin.

The above composition, wherein the wax is bees wax, a vegetable based wax, a hydrocarbon based wax, or mixtures thereof.

The above composition, wherein the wax is Gulf Wax.

The above composition, wherein the hardener is Elastollan®, Luran®, Terluran®, Ultramid® T, ACRYLITE PLUS®, Ferrene, ARCEL®, Crystal PS, Cevian®-V, Elvax, or mixtures thereof.

The above composition, wherein the hardener is Elvax-60.

The above composition, wherein the emulsifier is arlacel 60, armotan ms, crill 3, crill k3, drewsorb 60, durtan 60, emsorb 2505, glycomul s, hodag sms, ionet s 60, liposorb s, liposorb s-20, montane 60, ms 33, ms33f, newcol 60, nikkol ss 30, nissan nonion sp 60, nonion sp 60, nonion sp 60r, rikemal s 250, sorbitan c, sorbitan stearate, sorbon 60, sorgen 50, span 55, span 60, or mixtures thereof.

The above composition, wherein the emulsifier is sorbitan monolaurate, sorbitan monopalmitate, sorbitan monostearate, sorbitan tristearate, sorbitan monooleate, sorbitan sesquioleate, sorbitan trioleate, sorbitan monooleate, sorbitan trioleate, or mixtures thereof.

The above composition, wherein the emulsifier is Span 60.

The above composition, wherein the oil is a food oil or a sweet syrup.

The above composition, wherein the oil is corn oil, molasses, glycerol, corn syrup, or mixtures thereof.

The above composition, wherein the chemical attractant is ammonium acetate, ammonium carbonate, ammonium bicarbonate, aqueous acetic acid, glacial acetic acid, or mixtures thereof.

The above composition, wherein the chemical attractant is ammonium acetate.

The above composition, wherein the phagostimulant is proteinaceous material, a sugar, or mixtures thereof.

The above composition, wherein the phagostimulant is sucrose.

The above composition, wherein the visual attractant is a green coloring agent or pigment, an orange coloring agent or pigment, a red coloring agent or pigment, or mixtures thereof.

The above composition, wherein the visual attractant is green food color, orange food color, red food color, or mixtures thereof.

The above composition, wherein the toxicant is avermectin, dichlorvos, dimethoate, malathion, methomyl, naled, phloxine, spinosad, triguard, or mixtures thereof.

A method for attracting insects comprising (or consisting essentially of or consisting of) placing in an area where said insects are to be attracted an insect attracting effective amount of the composition described herein.

The above method, wherein the insects are frugivorous pest insects.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Mortality (mean ± std. dev) of Caribbean fruit
fly females, ten per bioassay, that were exposed to
baiting systems made from a three component
basic matrix (3CBM) and various additives for either 4 or 24 h

| | Mortality | Mortality |
|---|---|---|
| Additive to 3CBM | after 4 h | after 24 h |
| Corn Syrup | 0.4 + 0.55a | 0.0 ± 0.00a |
| Corn Syrup + 1% AI Spinosad | 5.2 ± 3.70b | 6.2 ± 2.95b |
| Glycerol + 1% AI Spinosad | 5.8 ± 3.27b | 6.2 ± 3.19b |
| Sugar + Corn Syrup + | 8.0 ± 1.58b | 8.2 ± 2.39b |
| 1% AI Spinosad | | |
| Sugar + 1% AI Spinosad | 8.0 ± 1.87b | 8.6 ± 0.89b |
| F value | 11.31 | 18.51 |
| df | 4, 20 | 4, 20 |
| P > F | A0.0001 | 0.0001 |

The three components that comprised the basic matrix are paraffin, a hardener (Elvax 60) and a emulsifier (SPAN 60) in a ratio of 8:1.5:0.5, respectively.
Means followed by same letter within a column are not significantly different (LSD mean separation test on square root [x + 0.5] transformed data, P = 0.05, means of non-transformed data shown).

TABLE 2
Percent mortality (mean ± std. dev) of Caribbean
fruit fly females that were exposed to baiting systems
with one of several toxicants at two concentrations for 4 h

| Toxicant | 0.25% AI | 1.0% AI |
|---|---|---|
| none (control) | 5.0 ± 7.07a | 5.0 ± 7.07a |
| triguard | 9.0 ± 11.97a | 4.0 ± 5.16a |
| methomyl | 74.8 ± 23.02b | 97.8 ± 4.64d |
| avermectin | 81.4 ± 16.75bc | 67.0 ± 20.03c |
| spinosad | 84.1 ± 24.16bc | 96.1 ± 6.90d |
| suredye | 83.0 ± 22.14bc | 22.0 ± 23.48b |
| dimethoate | 95.1 ± 7.00c | 99.0 ± 3.16d |
| F value | 47.30 | 124.10 |
| df | 6, 63 | 6, 63 |
| P > F | 0.0001 | 0.0001 |

Percent mortality was determined after 24 h for ten replicate tests of 10 females per test.
Means followed by the same letter within a column are not significantly different (LSD mean separation test, P = 0.05).

TABLE 3
Percent mortality (mean ± std. dev) of Mediterranean
fruit fly females that were exposed to baiting systems
with or without (control) toxicant for 4 h

| | Mortality after 4 h | | Mortality after 24 h | |
|---|---|---|---|---|
| | | BSC.1 | | BSC.1 |
| Toxicant | BSC.1 strip | cylinder | BSC.1 strip | cylinder |
| Control | 0.0 ± 0.00 | 1.4 ± 6.39 | 0.5 ± 2.13 | 1.0 ± 4.26 |
| 1% AI | 95.7 ± 10.94 | 99.1 ± 2.94 | 97.6 ± 6.83 | 99.1 ± 2.94 |
| Spinosad | | | | |
| 1% AI | 91.0 ± 8.68 | 96.2 ± 4.86 | 93.8 ± 9.99 | 98.1 ± 4.99 |
| Methomyl | | | | |

Percent mortality was determined for ten replicate tests of 10 females per test.

TABLE 4
Number (mean ± std. dev) of Caribbean fruit flies
that were captured in McPhail traps baited with putrescine
lures and baiting systems containing ammonium acetate (AA)
or with a standard ammonium acetate lure in field tests
conducted in Miami, FL

| | Number of |
|---|---|
| Treatment | Flies Captured |
| Baiting systems with 1 gm AA + putrescine lure | 0.8 ± 1.21a |
| Baiting systems with 2 gm AA + putrescine lure | 2.5 ± 2.33ab |
| Baiting systems with 3 gm AA + putrescine lure | 4.3 ± 4.96b |
| AA lure + putrescine lure | 5.8 ± 8.23b |
| F value | 3.61 |
| df | 3, 42 |
| P > F | 0.0208 |

Means followed by the same letter within a column are not significantly different (LSD mean separation test of log [x + 1] transformed data, P = 0.05, means of non-transformed data shown).

I claim:

1. A composition for attracting insects, comprising wax, a hardener, an emulsifier, an oil, a chemical attractant, and a phagostimulant, and optionally a visual attrantant, and optionally a toxicant.

2. The composition according to claim 1, wherein said wax is parraffin.

3. The composition according to claim 1, wherein said wax is selected from the group consisting of bees wax, a vegetable based wax, a hydrocarbon based wax, and mixtures thereof.

4. The composition according to claim 1, wherein said wax is Gulf Wax.

5. The composition according to claim 1, wherein said hardener is selected from the group consisting of Elastollan®, Luran®, Terluran®, Ultramid® T, ACRYLITE PLUS®, Ferrene, ARCEL®, Crystal PS, Cevian®-V, Elvax, and mixtures thereof.

6. The composition according to claim 1, wherein said hardener is Elvax-60.

7. The composition according to claim 1, wherein said emulsifier is selected from the group consisting of arlacel 60, armotan ms, crill 3, crill k3, drewsorb 60, durtan 60, emsorb 2505, glycomul s, hodag sms, ionet s 60, liposorb s, liposorb s-20, montane 60, ms 33, ms33f, newcol 60, nikkol ss 30, nissan nonion sp 60, nonion sp 60, nonion sp 60r, rikemal s 250, sorbitan c, sorbitan stearate, sorbon 60, sorgen 50, span 55, span 60, and mixtures thereof.

8. The composition according to claim 1, wherein said emulsifier is selected from the group consisting of sorbitan-monolaurate, sorbitan monopalmitate, sorbitan mono stearate, sorbitan tristearate, sorbitan monooleate, sorbitan sesquioleate, sorbitan trioleate, sorbitan monooleate, sorbitan trioleate, and mixtures thereof.

9. The composition according to claim 1, wherein said emulsifier is Span 60.

10. The composition according to claim 1, wherein said oil is selected from the group consisting of a food oil, a sweet syrup, and mixtures thereof.

11. The composition according to claim 1, wherein said oil is selected from the group consisting of corn oil, molasses, glycerol, corn syrup, and mixtures thereof.

12. The composition according to claim 1, wherein said chemical attractant is selected from the group consisting of ammonium acetate, ammonium carbonate, ammonium bicarbonate, aqueous acetic acid, glacial acetic acid, and mixtures thereof.

13. The composition according to claim 1, wherein said chemical attractant is ammonium acetate.

14. The composition according to claim 1, wherein said phagostimulant is selected from the group consisting of proteinaceous material, a sugar, and mixtures thereof.

15. The composition according to claim 1, wherein said phagostimulant is sucrose.

16. The composition according to claim 1, wherein said visual attractant is selected from the group consisting of a green coloring agent or pigment, an orange coloring agent or pigment, a red coloring agent or pigment, and mixtures thereof.

17. The composition according to claim 1, wherein said visual attractant is selected from the group consisting of green food color, orange food color, red food color, and mixtures thereof.

18. The composition according to claim 1, wherein said toxicant is selected from the group consisting of avermectin, dichlorvos, dimethoate, malathion, methomyl, naled, phloxine, spinosad, triguard, and mixtures thereof.

19. A method for attracting insects comprising placing in an area where said insects are to be attracted an insect attracting effective amount of the composition according to claim 1.

20. The method according to claim 19, wherein said insects are frugivorous pest insects.
